(19) United States
(12) Patent Application Publication
(10) Pub. No.: US 2002/0141382 A1
(43) Pub. Date: Oct. 3, 2002

(54) Wireless communication network for enabling internet access

(76) Inventors: Matthew T. Winther, Tempe, AZ (US); Jeffrey A. Clark, Chandler, AZ (US); Matthew C. Clark, Chandler, AZ (US)

Correspondence Address: Lowell W. Gresham, MESCHKOW & GRESHAM, P.L.C., Suite 409, 5727 North Seventh Street, Phoenix, AZ, 85014, US

(21) Appl. No.: 09/808,198

(22) Filed: Mar. 13, 2001

(51) Int. Cl. H04L 12/66

(52) U.S. Cl. 370/352; 370/401; 370/468

(57) ABSTRACT

A fixed wireless communication network (20) is configured to transfer Internet Protocol (IP) data packets (122) between customer devices, or local area networks (22), located at customer premises (24) and the Internet. The wireless network (20) includes subscriber nodes (26) located at the customer premises (24). Each of the subscriber nodes (26) includes a router (108) interconnected with one of the local area networks (22) at the customer premise (24) for receiving the IP data packets (122) from the local area network (22). A control node (28) is in wireless communication with subscriber nodes (26) over the industrial, scientific, and medical (ISM) band for transmitting the IP data packets (122). A network aggregation node (30) is in communication with the control node (28) and enables transfer of the IP data packets (122) between the control node (28) and an Internet backbone (50).

### TECHNICAL FIELD OF THE INVENTION

The present invention relates to the field of communication networks. More specifically, the present invention relates to wireless communication networks for transferring data packets between customer devices and the Internet.

### BACKGROUND OF THE INVENTION

The worldwide network of computers commonly referred to as the “Internet” has seen explosive growth in the last several years. The proliferation of the Internet, increased dependence on data, and a global trend toward deregulation of the telecommunications industry are driving efforts to satisfy a worldwide appetite for greater transmission capacity (i.e., bandwidth) and more efficient use of finite bandwidth. The phenomenon is particularly evident in the quest to alleviate the local loop bottleneck. The local loop bottleneck occurs where local-area networks (LANs), which link devices within a building or a campus, join to wide-area networks (WANs), which crisscross countries and hold the Internet together.

Advances in fiber technology have extended the capacity of WANs to trillions of bits per second. Meanwhile, LANs are evolving from ten megabits per second (Mbps) to gigabits per second. The local loop bottleneck has resulted because the connections between these two domains have not kept pace. That is, the vast majority of copper-wire circuits are limited to about the one and a half Mbps rate of a T1 digital transmission link. The typical home user faces a more extreme case of the same problem, with data moving between computer and the Internet about thirty times slower, through a modem and phone line operating at less than fifty-six kilobits per second.

As the demand for connectivity increases, coupled with the expenses of installing a copper or fiber network and the data rate limitations of a wired network, the telecommunications industry has been compelled to look for alternative methods for achieving cost effective, high performance Internet access. One such technique is through the implementation of fixed wireless network for enabling Internet access.

Generally, a fixed wireless network includes a stationary transceiver at the home or business receiving the service. The transceiver is pointed toward a radio transmission tower to send and receive signals. The radio transmission tower can send and receive high-speed Internet data. A fixed wireless network is advantageous over conventional wired networks in that Internet service providers (ISPs) need not dig up city streets to install new cable or replace outdated, legacy copper loops. Moreover, an ISP can distribute Internet bandwidth without the entanglements of leasing or maintaining hard-wired connections or phone lines through the use of the fixed wireless network.

One technique employed in fixed wireless networks is a local multipoint distribution service (LMDS). LMDS is configured to deliver data through the air at rates of up to one hundred fifty-five Mbps. The high capacity of LMDS is possible because it operates in a large, previously unallocated expanse of the electromagnetic spectrum. Depending upon the local licensing regulations of a particular country, LMDS operates anywhere from two to forty-two gigahertz (GHz). Unfortunately, the licensing of this spectrum undesirably drives up the cost of the LMDS system. In addition, the costs of the transceivers of the LMDS system are cost prohibitive for small business and home applications.

Yet another problem exists with prior art fixed wireless networks. That is, many conventional fixed wireless networks are flat networks. Flat networks typically employ bridges, hubs, or OSI Layer 2 switches. A flat network is protocol-specific, relatively inexpensive, and moderately fast for low traffic levels. An exemplary, flat, fixed wireless network includes a wireless bridge at a cell site that communicates with a wireless bridge at a customer premise. The wireless bridge at the customer site is connected via wireline connection to a LAN network router, such as an Ethernet-to-Ethernet router. The LAN router is then connected to a junction of a LAN at the customer premise for routing packets through the customer LAN.

Due in part to the number of interconnected pieces at the customer premise, such a system is cost prohibitive for small business and home applications. In addition, the components at the customer premise are typically located indoors, with a coaxial cable directed from an antenna mounted to the roof-top of the premise into the building and connecting to the wireless bridge. Such a system requires a long radio frequency (RF) run to the roof-top antenna. Unfortunately, a long RF run drives the need for high power, more costly, radio signals due to signal losses in the cable. Furthermore, flat networks tend to be limited in terms of scalability (i.e., size they can grow to with respect to Internet Protocol traffic).

Another problem with flat networks is that each internetworking device shares the bandwidth. That is, flat networks suffer from transmission efficiency problems because upstream routing functions (such as prioritization) are performed at the cell sites, rather than at the customer premise. Such a scenario is problematic because the inefficient control of data packet transmission from customer premises can lead to congestion and a high number of transmission errors caused by broadcast traffic on the flat network. This congestion and high number of transmission errors ultimately lowers the quality of service to the customer and decreases customer satisfaction.

Internet service providers do not offer multiple levels of service using the same wireless Internet access equipment. In other words, the flat Internet access networks currently offered by Internet service providers cannot accommodate both high priority, high speed users to low priority, low speed users while managing the problems of congestion caused by broadcast traffic since all users are sharing the bandwidth. This drives the need for customer specific hardware configurations at the customer premises and at the Internet access points for accommodating the level of priority-based routing and transmission speed desired by the customer. Customer specific hardware configurations undesirably drive up the cost of providing wireless Internet access in terms of hardware cost and deployment cost.

### SUMMARY OF THE INVENTION

Accordingly, it is an advantage of the present invention that a communication network is provided for enabling customer devices access to the Internet.

Another advantage of the present invention is that the communication network facilitates the transfer of data packets between the customer devices and the Internet via wireless communication.

Another advantage of the present invention is that the network effectively accomplishes priority-based routing and bandwidth allocation at the customer premises.

Yet another advantage of the present invention is that the network includes cost effective, reconfigurable equipment at cell sites and customer premises.

The above and other advantages of the present invention are carried out in one form by a communication network for transferring data packets between customer devices and the Internet, the customer devices being located at customer premises. The network includes subscriber nodes located at the customer premises. Each subscriber node includes a router interconnected with the customer devices at the customer premise. A control node is in wireless communication with the subscriber nodes using a prescribed restricted frequency band, the prescribed restricted frequency band being used for transmitting the data packets. A network aggregation node is in communication with the control node for enabling transfer of the data packets between the customer devices and an Internet backbone.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a fixed wireless communication network for providing customer devices located at customer premises access to the Internet;

FIG. 2 shows a block diagram of an environment in which the fixed wireless communication network may be deployed;

FIG. 3 shows a perspective view of a subscriber node of the fixed wireless communication network of FIG. 1;

FIG. 4 shows a block diagram of a second unit of the subscriber node;

FIG. 5 shows a simplified block diagram of router in a first unit of the subscriber node;

FIG. 6 shows an exemplary Internet Protocol (IP) data packet; and

FIG. 7 shows a block diagram of an exemplary configuration of a control node of the fixed wireless communication network of FIG. 1.

### DETAILED DESCRIPTION OF THE PREFERRED EMBODIMENTS

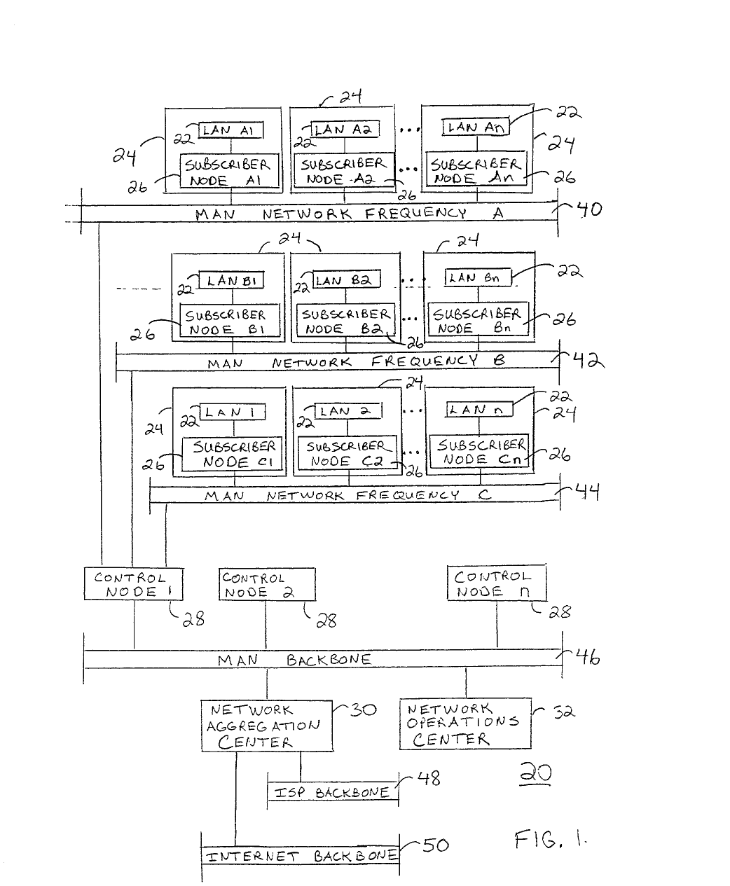

FIG. 1 shows a block diagram of a fixed wireless communication network 20 for providing customer devices 22 located at customer premises 24 access to the Internet. Communication network 20 is desirably deployed in a city-wide environment as a metropolitan area network (MAN). A MAN is a data network covering an area larger than a local area network (LAN), but less than a wide area network (WAN). A MAN typically interconnects two or more LANs, operates at a higher speed, may cross administrative boundaries, and may use multiple access methods. Communication network 20 may carry data, voice, video, image, and multimedia data. Fixed wireless communication network 20 will be referred to hereinafter as wireless MAN 20 to distinguish it from local area networks (LANs) and wide area networks (WANs), discussed below.

Wireless MAN 20 generally includes subscriber nodes 26, control nodes 28, a network aggregation center 30, and a network operations center 32. Subscriber nodes 26 are located at customer premises 24 and connect via a wired connection to customer devices 22.

Customer devices 22 are shown as local area networks (LAN A1, LAN A2, LAN An, LAN B1, and so forth), and subscriber nodes 26 desirably interconnect at a junction of these LANs. LANs are short distance data communications networks used to link computers and peripheral devices, such as printers, CD-ROMs, and modems, under some form of standard control. Customer devices 22 will be referred to hereinafter as LANs 22. LANs 22 may be located in businesses, schools, homes, and so forth.

Subscriber nodes 26 provide LANs 22 high-speed access to the Internet, in compliance with the IEEE 802.11 wireless LAN standard. The IEEE 802.11 wireless LAN standard places specifications on the parameters of both the physical (PHY) and medium access control (MAC) layers of the network. The PHY layer, which actually handles the transmission of data packets between nodes, can use either direct sequence spread spectrum, frequency-hopping spread spectrum, or infrared (IR) pulse position modulation. IEEE 802.11 supports data rates of 1, 2, 5.5, and 11 Mbps. In addition, IEEE 802.11 calls for operation in a restricted frequency band, in particular, the 2.4-2.4835 gigahertz (GHz) frequency band (in the case of spread-spectrum transmission), which is an unlicensed band for industrial, scientific, and medical (ISM) applications, and 300-428,000 GHz for IR transmission.

Control nodes 28 serve as cell sites in wireless communication with subscriber nodes 26 within MAN 20. Each of control nodes 28 is a wireless point of presence (WPOP). As known to those skilled in the art, a WPOP denotes a central facility or hub where subscribers are linked via wireless connection to access the Internet Service Provider's (ISP's) broadband backbone. A WPOP is advantageous over land line connectivity because it is high-speed (up to 11 Mbps versus a dial up connection or 1.544 Mbps T-1 line), it is reliable, it has low deployment cost relative to other last mile solutions, it is inexpensive to upgrade, there is no local telephone company involvement, and it may be owned and managed by a single entity.

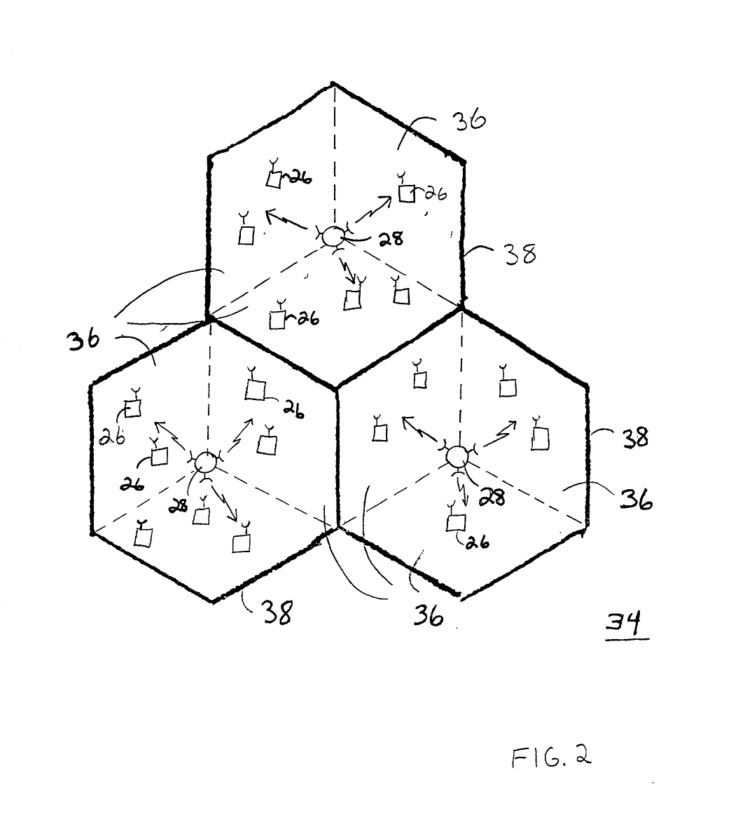

FIG. 2 shows a block diagram of an environment 34 in which fixed wireless communication network 20 (FIG. 1) may be deployed. Control nodes 28 provide radio frequency coverage over prescribed coverage areas, or sectors 36, of cells 38. Control nodes 28 utilize IEEE 802.11 compliant equipment and desirably have a 5-10 mile radius of coverage. Thus, subscriber nodes 26, located at customer premises 24 (FIG. 1), are located within one of sectors 36 managed by one of control nodes 28. Subscriber nodes 26 communicate with particular ones of control nodes 28 using a prescribed restricted frequency band in the unlicensed ISM band.

Environment 34 is shown with only three of cells 38 for clarity of illustration. However, it should be understood that environment 34 may be subdivided into any number of cells 38 in order to provide city-wide or near city-wide radio frequency coverage using wireless MAN 20 (FIG. 1). Likewise, each of cells 38 is subdivided into three of sectors 36 for clarity of illustration. However, cells 38 may be subdivided into more or less sectors 36 in response to a quantity of users of wireless MAN 20 (FIG. 1) in a particular region and their desired level of service (discussed below). Thus, wireless MAN 20 (FIG. 1) can be scaled to accommodate the actual, or projected, number of users and their level of service within environment 34.

Referring back to FIG. 1, a direct sequence signaling technique can divide the 2.4 GHz ISM band into fourteen channels each having a bandwidth of twenty-two MHz. Adjacent channels overlap one another partially, with three of the fourteen being completely non-overlapping. As shown in wireless MAN 20, subscriber nodes 26, labeled A1, A2, through An, are in communication with one of control nodes 28, labeled CONTROL NODE 1, via a first frequency 40, labeled MAN NETWORK FREQUENCY A, of the 2.4-2.4835 gigahertz ISM band. Likewise, subscriber nodes 26, labeled B1, B2, through Bn, are in communication with the one of control nodes 28, i.e., CONTROL NODE 1, via a second frequency 42, labeled MAN NETWORK FREQUENCY B, of the ISM band. Subscriber nodes 26, labeled C1, C2, through Cn, are in communication with the one of control nodes 28, i.e., CONTROL NODE 1, via a third frequency 44, labeled MAN NETWORK FREQUENCY C, of the ISM band.

In an exemplary embodiment, control node 28, labeled CONTROL NODE 1, is configured to transmit using one of first, second, and third frequencies 40, 42, and 44 in each sector 36 (FIG. 2) of a particular one of cells 38 (FIG. 2) for which control node 28 provides radio frequency coverage. However, since first, second, and third frequencies 40, 42, and 44 are non-overlapping, control node 28 may be configured to transmit using two or three of frequencies 40, 42, and 44 in each sector 36 (FIG. 2) for which control node 28 provides radio frequency coverage. Thus, wireless MAN 20 (FIG. 1) can be further scaled to accommodate the actual, or projected, number of users and their level of service within environment 34.

Only a few of subscriber nodes 26 are shown for clarity of illustration in FIG. 1. However, ellipses indicate that any quantity of subscriber nodes 26 may be included, limited in number by quality of service and bandwidth prioritization considerations, discussed below. In addition, only a few of control nodes 28 are shown for clarity of illustration. However, an ellipsis between control nodes 28 indicates that any quantity of control nodes 28 may be included for providing city-wide or near city-wide coverage by wireless MAN 20.

Control nodes 28 connect to a backbone 46 of wireless MAN 20. MAN backbone 46 is an aggregate of high-speed wired and wireless connections that forms a major pathway within wireless MAN 20. MAN backbone 46 joins control nodes 28 in communication with network aggregation center 30 and network operations center 32. Network aggregation center 30 is in communication with an Internet Service Provider (ISP) backbone 48 and/or an Internet backbone 50 for enabling the transfer of data packets (discussed below) between customer devices 22 and Internet backbone 50. Network operations center 32 generally monitors the status of wireless MAN 20, supervises and coordinates wireless MAN 20 maintenance, and accumulates accounting, usage data, and user support.

As will become readily apparent in the following discussion, wireless MAN 20 is configured to efficiently manage communication traffic between subscriber nodes 26 and Internet backbone 50 in response to a predetermined level of service for each of subscriber nodes 26.

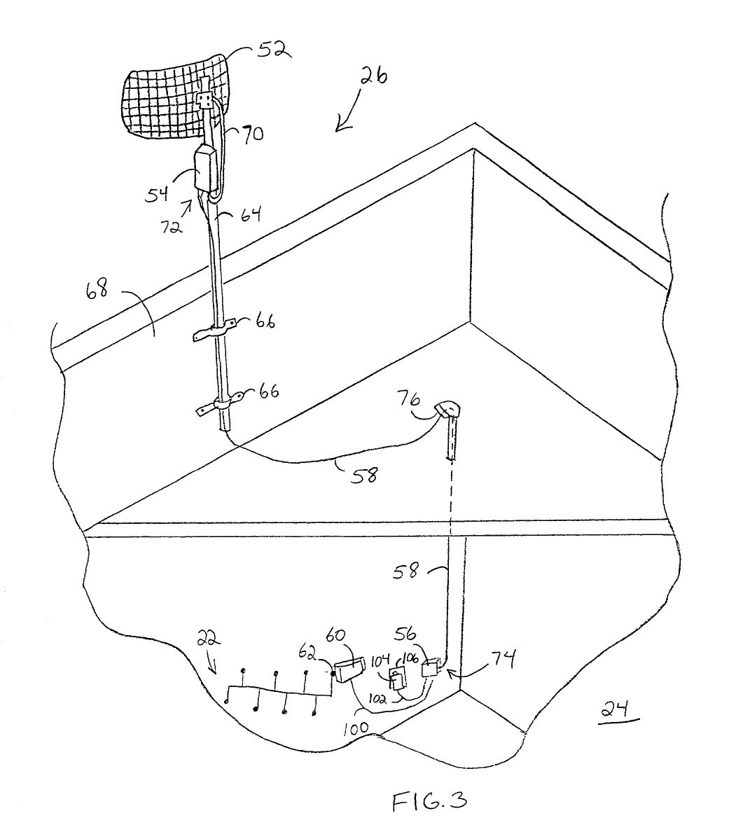

FIG. 3 shows a perspective view of one of subscriber nodes 26 of wireless MAN 20 (FIG. 1) at one of customer premises 24. Subscriber node 26 is configured as an interface between one of LANs 22 and one of control nodes 28 (FIG. 2). Subscriber node 26 generally includes an antenna 52, a first unit 54, a second unit 56, a cable 58 interconnecting first unit 54 and second unit 56, and a network hub 60 coupled between second unit 56 and a junction 62 of LAN 22. For clarity of illustration, LAN 22 is arranged in a bus topology and employs an Ethernet media-access control method.

In a preferred embodiment, antenna 52 is a grid antenna suitable for directional 2.4 GHz ISM band applications. Antenna 52 desirably provides a predetermined gain and a predetermined beam-width for optimal communication between subscriber node 26 and control node 28 (FIG. 1). A grid antenna is desirable for use at subscriber node 26 because it is nearly undetectable in most installations, it is durable, and it can be installed for either vertical or horizontal polarization. A grid antenna may also include a built-in tilt mechanism that allows installation at various degrees of incline for easy alignment. Although antenna 52 is described in terms of a grid antenna, it should be understood that other types of antennas may alternatively be employed for directional 2.4 GHz ISM band application.

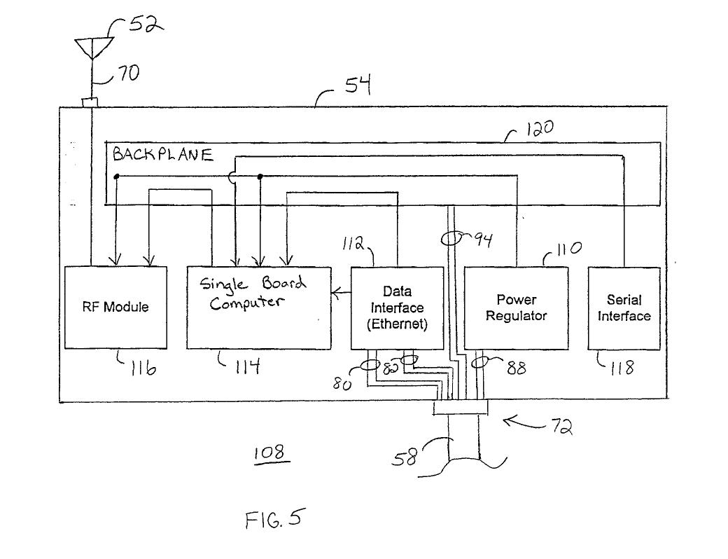

A mast 64 of antenna 52 is mounted to an external portion of customer premise 24. For example, anchors 66 secure mast 64 to a parapet 68 of customer premise 24. First unit 54 is located proximate antenna 52 and external to customer premise 24. In this exemplary embodiment, first unit 54 is mounted to mast 64. As such, a housing of first unit 54 is desirably manufactured from a durable, weather resistant material. The components of first unit 54 will be described below in connection with FIG. 5.

A coaxial cable 70 is directed between antenna 52 and first unit 54 for conveying radio frequency signals in the 2.4 GHz ISM band between antenna 52 and first unit 54. Coaxial cable 70 may include a reverse polarity threaded nut coupling (TNC) connector for connection to first unit 54. In a preferred embodiment, first unit 54 is located proximate antenna 52 so that coaxial cable 70 is as short as possible, for example, less than two feet long. By configuring coaxial cable 70 to be very short, signal strength loss of the radio frequency signals conveyed by coaxial cable 70 is minimized. Since little signal strength is lost through coaxial cable 70, a radio frequency signal can be transmitted at relatively low power, thus, decreasing costs associated with high power transmission and decreasing the potential for interference.

Cable 58 has a first end 72 connected to first unit 54. In an exemplary embodiment, first end 72 includes a watertight connector, for example, NEMA 4X standard connector, for coupling to a receptacle on first unit 54. A second end 74 of cable 58 is routed through a penetration location 76 into the inside of customer premise 24. Second end 74 of cable 58 does not include a connector, so that the size of penetration location 76 may be kept as small as possible. Second end 74 is coupled to second unit 56.

Cable 58 is desirably manufactured from a durable, weather resistant material to withstand exposure to wind, moisture, and sun. For example, cable 58 may be ultraviolet (UV) rated category five (Cat 5) cable. Cat 5 cable is typically unshielded twisted pair, containing four twisted wire pairs. Two of these pairs are used for 100 Mbps (100Base-T) and 10 Mbps (10Base-T) Ethernet applications, leaving two pairs unused.

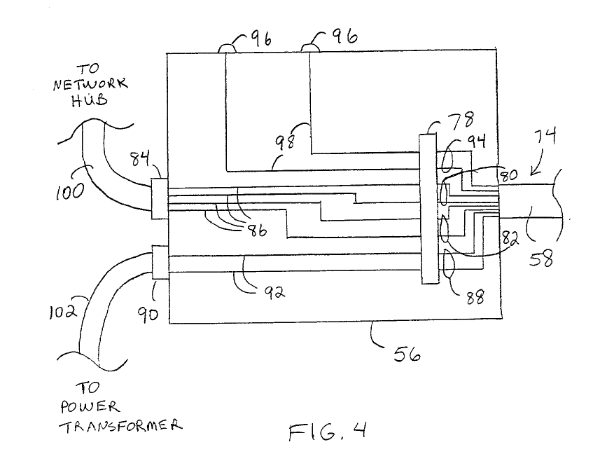

FIG. 4 shows a block diagram of second unit 56 of the subscriber node 26 (FIG. 3). Second end 74 of cable 58 is coupled to second unit 56 using a conventional telecommunications type punch down connector 78. A first twisted wire pair 80 and a second twisted wire pair 82 of cable 58 are coupled to connector 78. First and second twisted wire pairs 80 and 82, respectively, are subsequently in communication with a data port 84 of second unit 56. Communication between pairs 80 and 82 and data port 84 may be achieved, for example, via traces 86 on a printed circuit board of second unit 56.

A third twisted wire pair 88 of cable 58 is in communication with a power input 90 of second unit 56. This communication between third twisted wire pair 88 and power input 90 may be achieved, for example, via traces 92 on the second unit 56 printed circuit board. A fourth twisted wire pair 94 may be optionally utilized to carry signaling information to light emitting diodes (LEDs) 96 on second unit 56 reserved to indicate subscriber node 26 and/or network status. This communication between fourth twisted wire pair 94 and LEDs 96 may be achieved, for example, via traces 98 on the second unit 56 printed circuit board.

Referring to both FIGS. 3-4, an Ethernet cable 100 is coupled between data port 84 and network hub 60. Ethernet cable 100 conveys data packets (discussed below) between traces 86 of second unit 56 and LAN 22. Due to the interconnection of traces 86 with first and second twisted wire pairs 80 and 82, respectively, at connector 78, these data packets are conveyed between second unit 56 and first unit 54.

A power cable 102 is coupled between power input 90 and a power transformer 104 connected to a conventional alternating current (AC) wall socket 106 at customer premise 24. Power transformer 104 converts the provided AC power into a direct current (DC) power. This DC power is conveyed to traces 92 of second unit 56. Due to the interconnection of traces 92 with third twisted wire pair 88 at connector 78, DC power is subsequently supplied to first unit 54.

Accordingly, cable 58 conveys data packets between LAN 22 and first unit 54. In addition, cable 58 carries DC power to energize the components (discussed below) of first unit 54. This single cable configuration simplifies the hardware configuration of subscriber node 26 and decreases installation time since only one cable is routed rather than separate cables for power and data. In addition, the size of penetration location 76 is advantageously minimized since only one cable is used, rather than two separate cables.

FIG. 5 shows a simplified block diagram of a router 108 in first unit 54 (FIG. 3) of subscriber node 26 (FIG. 3). Router 108 is interconnected with LAN 22 via cable 58 (FIG. 3) and second unit 56 (FIG. 3). Router 108 performs bridging and routing functions. That is, router 108 performs the conventional bridging functions of accepting data packets from control nodes 28 and forwarding them to LAN 22 (FIG. 3). In addition, router 108 performs routing functions of accepting data packets from LAN 22 and routing them to one of control nodes 28.

Routing functions, such as establishing data connectivity with a WAN, bandwidth allocation, and data packet prioritization are typically performed at the wireless point of presence (WPOP) in fixed wireless communication networks. Router 108 of subscriber node 26 (FIG. 3) advantageously performs these routing functions at customer premise 24 (FIG. 3) to provide LAN 22 (FIG. 3) access to the Internet.

The use of router 108 at each of subscriber nodes 26 (FIG. 1) allows routing decisions to be made based upon a desired level of service related to specific subscriber nodes 26 and current traffic loads over the ISM band used for communication between subscriber nodes 26 and control nodes 28 (FIG. 1). Through the use of router 108 at each of subscriber nodes 26, overall network efficiency increases thereby increasing customer satisfaction.

In general, router 108 includes a power regulator 110, an Ethernet data interface 112, a single board computer 114, a radio frequency module 116, and a serial interface 118 all of which are interconnected via a backplane 120. In addition, radio frequency module 116 is coupled to antenna 52 via coaxial cable 70.

As discussed previously, cable 58 is a Cat 5 cable containing four twisted wire pairs. Third twisted wire pair 88, carrying DC power from second unit 56, is coupled to power regulator 110. Power regulator 110 regulates the DC power received from second unit 56 via third twisted wire pair 88 of cable 58 to mitigate transients in the received DC power. For example, power regulator 110 serves to regulate and step down a received power from 12-24 volts DC to 3-5 volts DC. This power is subsequently delivered to other components within second unit 54 via backplane 120.

First and second twisted wire pairs 80 and 82, respectively, of cable 58 are coupled to Ethernet data interface 112 for conveying data packets (discussed below) between router 108 and the interconnected LAN 22 (FIG. 3). In a preferred embodiment, Ethernet data interface 112 is a commercial off-the-shelf (COTS) Ethernet card CompactFlash Type 1 form factor configured to fit in a Type 1 or Type 2 Personal Computer Memory Card International Association (PCMCIA) PC interface slot on single board computer 114 or alternatively on backplane 120.

Single board computer 114 is a COTS circuit board that typically contains a microprocessor, ROM and RAM, serial I/O lines, and parallel I/O ports. Single board computer 114 serves as the main processing unit or controller for router 108. In a preferred embodiment, single board computer 114 is a 486CORE module manufactured by Compulab, Haifa, Israel. The 486CORE module is an embedded PC-compatible single board computer designed to serve as a building block in applications' design. It should be understood, however, that a number of existing and upcoming COTS single board computers are equivalently suitable to serve as single board computer 114.

Single board computer 114 employs an open source computing platform. In other words, single board computer 114 is programmed via serial interface 118 using open source software. Open source software is advantageous because it is freely distributed along with its source code. The source code can be changed readily so that the program stored in single board computer 114 can be altered to add advanced routing features.

In a preferred embodiment, Linux is employed in single board computer 114 as the open source software. Linux is a full-featured, powerful, and robust Unix operating system. Through the use of the Linux open source software, router 108 is configured to establish data connectivity (i.e., interface) between control nodes 28 (FIG. 1) and subscriber nodes 26 (FIG. 1) and to achieve isolation between subscriber node 26 and the rest of wireless MAN 20 (FIG. 1). In addition, the Linux open source software is used to manage bandwidth between subscriber node 26 (FIG. 3) and control node 28 in order to fairly share bandwidth of the ISM band between subscriber nodes 26 and control node 28 (FIG. 1).

Accordingly, single board computer 114 utilizes the routing capabilities provided through the execution of a program that employs a Linux open source computing platform to configure and enable the transmission of data packets (discussed below) from antenna 52 via radio frequency module 116. Radio frequency module 116 is a COTS transceiver suitable for the 2.4 GHz ISM band applications for sending and receiving data packets. In addition, radio frequency module 116 includes collision detection capability for the detection of simultaneous transmissions that can result in transmission errors.

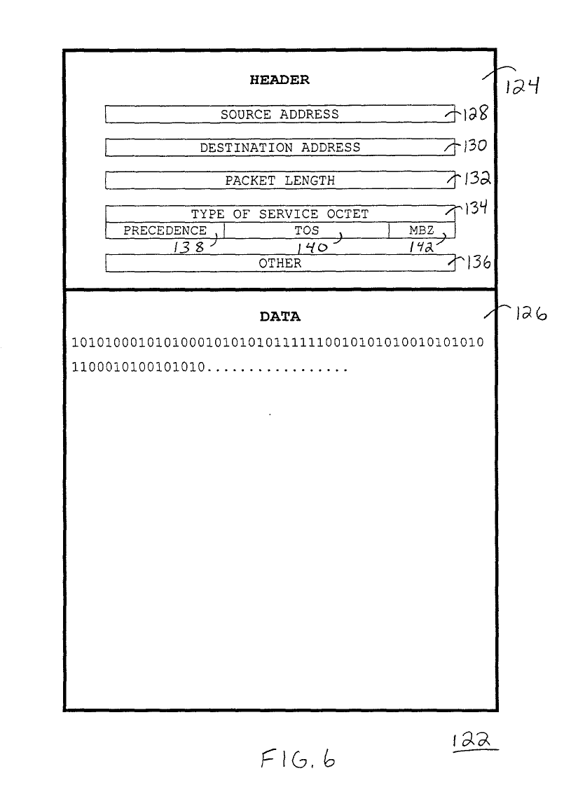

FIG. 6 shows an exemplary Internet Protocol (IP) data packet 122, also known to those skilled in the art as an IP datagram. IP data packet 122 is the fundamental unit of information passed across the Internet. IP data packet 122 includes, among other things, a header 124 and data 126. Header 124 contains control information such as a source address 128, a destination address 130, a packet length 132, a type of service octet 134, and other control information 136, such as synchronizing bits. Data 126 is the payload or text to be transmitted.

Router 108 (FIG. 5) manages bandwidth allocation for the transmission of IP data packet 122 over the ISM band and manages the transmission priority of IP data packet 122. The management of bandwidth allocation entails the provision of varying levels of throughput of IP data packets 122 based on a predetermined level of service for subscriber node 26 (FIG. 3). Likewise, the management of transmission priority entails setting a transmission priority for each of a number of IP data packets 122 in response to the predetermined level of service. The transmission priority ultimately affects the order, or sequence, in which IP data packets 122 are transmitted from a number of subscriber nodes 26 (FIG. 1) using the same one of first, second, and third frequencies 40, 42, and 44, respectively (FIG. 1).

Router 108 manages bandwidth allocation and prioritization by setting, or altering, type of service octet 134 for each IP data packet 122 received by router 108 from LAN 22 (FIG. 3). Type of service octet 134 includes a precedence field 138, a type of service (TOS) field 140, and an MBZ (must be zero) field 142. Precedence field 138 is used to denote the importance or priority of IP data packet 122. Type of service field 140 is used to denote how wireless MAN 20 (FIG. 1), including router 108, should make tradeoffs between throughput, delay, reliability, and cost. MBZ field 142 is typically unused and set to zero.

Router 108 sets the three bits of precedence field 138 to affect prioritization of the transmission of IP data packet 122 through wireless MAN 20 (FIG. 1). In an exemplary embodiment of the present invention, wireless MAN 20 may include three levels of prioritization, i.e., precedence. These three levels may include a priority 1 (P1) level of service. P1 service is equivalent to point-to-point broadband connectivity typically offered on a wired medium. A P1 level of service is intended for businesses with significant data requirements, and may have a performance equivalent to T-1 (1.544 Mbps), E-1 (2.048 Mbps), T-3 (44.736 Mbps), DS-3 (44.736 Mbps), and so forth.

A second level of service may include a priority 2 (P2) level of service. P2 service communication traffic yields to P1 service communication traffic. That is, P2 traffic has a lower transmission priority than P1 traffic. A P2 level of service is intended for small to medium sized businesses and/or residential customers, and is comparable to Symmetrical DSL (1 Mbps, both ways) services.

A third level of service may include a priority 3 (P3) level of service. P3 service communication traffic yields to both P1 and P2 service communication data traffic. That is, P3 traffic has a lower transmission priority than both P1 and P2 traffic. A P3 level of service is intended for home-based consumers, but offers burst downloads. As a result, P3 service exceeds conventional cable modem transmission speed.

Although the present invention is described in terms of three levels of service, it should be understood that through the use of the Linux open source computing platform, an Internet Service Provider (ISP) may utilize precedence field 138 of IP data packet 122 to distinguish a number of levels of service, in accordance with ISP preferred transmission rates and billing schedules.

Router 108 may set the four bits of TOS field 140 to affect tradeoffs between throughput, delay, reliability, and cost. By way of example, bits of TOS field 140 may be set as shown in the following TOS bit table:

TOS BIT TABLE

| TOS VALUE | REQUESTED TOS |
|---|---|
| 1000 | minimize delay |
| 0100 | maximize throughput |
| 0010 | maximize reliability |
| 0001 | minimize monetary cost |
| 0000 | normal service |

Accordingly, varying levels of service can be set for each of subscriber nodes 26 (FIG. 1) through the setting of precedence field 138 and TOS field 140 of type of service octet by router 108. These varying levels of service allow wireless MAN 20 to provide a segmented system that can accommodate both high priority, high speed subscribers and low priority, low speed subscribers using the same equipment, i.e., subscriber node 26 (FIG. 5).

Such a segmented system is advantageous to the Internet Service Provider because the ISP can charge varying rates, depending upon the desired level of service. Likewise, a segmented system is advantageous to the subscriber because the subscriber can decide which level of service is preferred, hence, pay for and receive that desired level of service. In addition, the hardware configuration at each of subscriber nodes 26 (FIG. 1) is the same regardless of the desired level of service. Moreover, the hardware configuration is based on COTS components. A common hardware configuration based on COTS components results in lower deployments costs of MAN 20 (FIG. 1).

Router 108 (FIG. 5) configures the transmission priority of IP data packets 122 (FIG. 6) by setting type of service octet 134 (FIG. 6) in response to a predetermined level of service for subscriber node 26 (FIG. 1). In addition, router 108 allocates bandwidth over a particular one of first, second, and third frequencies 40, 42, and 44 (FIG. 1) in accordance with the predetermined level of service. Router 108 also establishes connectivity with one of control nodes 28.

When one of control nodes 28 receives an IP data packet, such as IP data packet 122 (FIG. 6), from one of subscriber nodes 26 (FIG. 1), control node 28 accesses type of service octet 134 (FIG. 6) to determine the transmission priority of IP data packet 122. Control node 28 then employs the transmission priority set in precedence field 138 (FIG. 6) and the preferred type of service set in TOS field 140 (FIG. 6) to facilitate transfer of IP data packet 122 onto MAN backbone 46 in order to forward IP data packet 122 to network aggregation center 30 (FIG. 1).

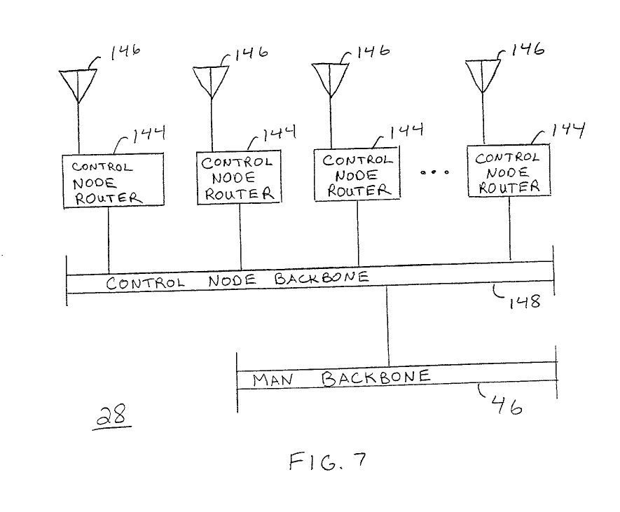

FIG. 7 shows a block diagram of an exemplary configuration of one of control nodes 28 of fixed MAN 20 (FIG. 1). Control node 28 includes a plurality of control node routers 144 and a plurality of directional antennas 146. One each of control node routers 144 is in communication with one each of directional antennas 146. A control node backbone 148 is in communication with each of control node routers 144 and network aggregation node 30 via MAN backbone 46.

As discussed previously, control node 28 provides radio frequency coverage over a prescribed coverage area, or cell 38 (FIG. 2). Furthermore, cell 38 is subdivided into a number of sectors 36 (FIG. 2). Each pair of control node routers 144 and directional antennas 146 desirably provides radio frequency coverage over one of sectors 36 using one of first, second, and third frequencies 40, 42, and 44, respectively (FIG. 1).

In a preferred embodiment, control node routers 144 are substantially identical to router 108 (FIG. 5). Likewise, directional antennas 146 are substantially identical to directional antenna 52 (FIG. 3). Accordingly, cost savings is achieved in the deployment of control nodes 28 by utilizing circuitry that is common to subscriber nodes 26 (FIG. 1). Furthermore, by using a control node router 144/directional antenna pair 146 for each ISM frequency used in each of sectors 36 (FIG. 2), control node 28 is readily scaled to accommodate the actual, or projected, number of users and their level of service within one of cells 38 of environment 34 (FIG. 2).

In summary, the present invention teaches of a fixed wireless communication network using the ISM frequency band for enabling customer devices access to the Internet. The wireless communication network facilitates the transfer of data packets between the customer devices and the Internet through the use of a router located at each customer premise and interconnected with the customer devices. The router employs an open source computing platform for enabling full routing capabilities at the subscriber nodes. In particular, the router performs priority-based routing of IP data packets and bandwidth allocation for the IP data packets at the customer premise, thereby, alleviating the problems of congestion and transmission errors caused by broadcast traffic on prior art flat networks. In addition, the fixed wireless network includes a common hardware configuration using COTS components at each subscriber node and at the control nodes which results in a cost effective, scalable, and readily deployed system.

Although the preferred embodiments of the invention have been illustrated and described in detail, it will be readily apparent to those skilled in the art that various modifications may be made therein without departing from the spirit of the invention or from the scope of the appended claims. The specification and drawings are, accordingly, to be regarded in an illustrative rather than restrictive sense.

What is claimed is:

1. A communication network for transferring data packets between customer devices and the Internet, said customer devices being located at customer premises, said network comprising:
subscriber nodes located at said customer premises, each of said subscriber nodes including a router interconnected with said customer devices at one of said customer premises for receiving said data packets from said customer devices;
a control node in wireless communication with said subscriber nodes over a prescribed restricted frequency band, said prescribed frequency band being used for transmitting said data packets; and
a network aggregation node in communication with said control node for enabling transfer of said data packets between said control node and an Internet backbone.

2. A communication network as claimed in claim 1 wherein said each subscriber node further includes:
an antenna mounted to an external portion of said one customer premise, said antenna being in communication with said control node over said restricted frequency band;
a first unit enclosing said router, said first unit being located proximate said antenna at said external portion of said one customer premise, and said router being in wired communication with said antenna;
a second unit located inside of said one customer premise, said second unit having a data port in data communication with said customer devices; and
a cable having a first end in communication with said router of said first unit and a second end in communication with said data port of said second unit, said cable being configured to convey said data packets between said data port and said router.

3. A communication network as claimed in claim 2 wherein said customer devices are interconnected via a local area network (LAN), and said each subscriber node further comprises a network hub coupled between said data port and a junction of said LAN.

4. A communication network as claimed in claim 2 wherein:
said cable is further configured to convey power to said outdoor unit; and
said second unit further comprises a power input in communication with said second end of said cable for providing said power to said cable.

5. A communication network as claimed in claim 1 wherein said router includes a processor employing an open source computing platform.

6. A communication network as claimed in claim 1 wherein said router allocates bandwidth for communication of said data packets between said each subscriber node and said control node in response to a predetermined level of service for said each subscriber node.

7. A communication network as claimed in claim 1 wherein said router establishes a transmission priority of said data packets to be transmitted between said each subscriber node and said control node in response to a predetermined level of service for said each subscriber node.

8. A communication network as claimed in claim 7 wherein said data packets are Internet Protocol (IP) packets, and said router sets a precedence field in a header of said IP packet to establish said transmission priority.

9. A communication network as claimed in claim 7 wherein said data packets are Internet Protocol (IP) packets, and said router sets a type of service (TOS) field in a header of each of said IP packets to establish said transmission priority.

10. A communication network as claimed in claim 7 wherein said control node employs said transmission priority, established at said router, to forward said data packets to said network aggregation center.

11. A communication network as claimed in claim 1 wherein said control node communicates with said plurality of subscriber units using an industrial, scientific, medical (ISM) band.

12. A communication network as claimed in claim 1 wherein said control node provides radio frequency coverage over a prescribed coverage area, and said control node comprises:
a plurality of control node routers;
a plurality of directional antennas, one each of said control node routers being in communication with one each of said directional antennas to provide said radio frequency coverage over a sector of said prescribed coverage area; and
a control node backbone in communication with said control node routers and said network aggregation node.

13. A fixed wireless network for transferring data packets between customer devices and the Internet, said customer devices being located at customer premises, said network comprising:
subscriber nodes located at said customer premises, each of said subscriber nodes including:
an antenna mounted to an external portion of one of said customer premises;
a first unit located proximate said antenna at said external portion of said one customer premise, said first unit enclosing a router, said router being in wired communication with said antenna, and said router having a processor employing an open source computing platform;
a second unit located inside of said one customer premise, said second unit having a data port in data communication with said customer devices; and
a cable having a first end in communication with said router of said first unit and a second end in communication with said data port of said second unit, said cable being configured to convey said data packets between said data port and said router so that said router is interconnected with said customer devices at said one customer premise;
a control node in wireless communication with said antennas of said subscriber nodes over a prescribed restricted frequency band, said prescribed restricted frequency band being used for transmitting said data packets; and
a network aggregation node in communication with said control node for enabling transfer of said data packets between said control node and an Internet backbone.

14. A fixed wireless network as claimed in claim 13 wherein:
said cable is further configured to convey power to said outdoor unit; and
said second unit further comprises a power input in communication with said second end of said cable for providing said power to said cable.

15. A fixed wireless network as claimed in claim 13 wherein said customer devices are interconnected via a local area network (LAN), and said each subscriber node further comprises a network hub coupled between said data port and a junction of said LAN.

16. A communication network as claimed in claim 13 wherein said router allocates bandwidth for communication of said data packets between said each subscriber node and said control node in response to a predetermined level of service for said each subscriber node.

17. A communication network as claimed in claim 13 wherein said router establishes a transmission priority for said data packets to be transmitted between said each subscriber node and said control node in response to a predetermined level of service for said each subscriber node.

18. A fixed wireless network as claimed in claim 13 wherein said control node communicates with said plurality of subscriber units using an industrial, scientific, medical (ISM) band.

19. A fixed wireless communication network for transferring Internet Protocol (IP) data packets between customer devices and the Internet, said customer devices being located at customer premises, said network comprising:
subscriber nodes located at said customer premises, each of said subscriber nodes including a router interconnected with said customer devices at one of said customer premises, said router being configured to allocate bandwidth and to establish a transmission priority for said IP data packets transmitted from said each subscriber node in response to a predetermined level of service for said each subscriber node;
a control node for receiving said IP packets, said control node being in wireless communication with said subscriber nodes over an industrial, scientific, medical (ISM) band; and
a network aggregation node in communication with said control node for enabling transfer of said IP data packets between said customer devices and an Internet backbone.

20. A fixed wireless communication network as claimed in claim 19 wherein said control node employs said transmission priority to forward said IP packets to said network aggregation center.
